(19) United States
(12) Patent Application Publication
(10) Pub. No.: US 2023/0305565 A1
(43) Pub. Date: Sep. 28, 2023

(54) SYSTEM FOR DETECTION, COLLECTION, AND REMEDIATION OF OBJECTS OF VALUE AT WASTE, STORAGE, AND RECYCLING FACILITIES

(71) Applicant: RUBICON TECHNOLOGIES, LLC, Lexington, KY (US)

(72) Inventor: Nathanial Morris, Lexington, KY (US)

(73) Assignee: RUBICON TECHNOLOGIES, LLC, Lexington, KY (US)

(21) Appl. No.: 17/703,948

(22) Filed: Mar. 24, 2022

(51) Int. Cl. G05D 1/02; G01V 8/10; G06Q 10/00

(52) U.S. Cl. CPC G05D 1/0214; G01V 8/10; G06Q 10/30; G05D 2201/0207

(57) ABSTRACT

A municipal solid waste or recycling facility item of interest identification, collection, and remediation system, controller, and computer program provide identification, collection, and remediation for items of interest included in waste at a municipal solid waste or recycling facility. The one or more controllers monitor data streams from sensors and/or image stream(s) from image capturing device(s) deposited on one or more mobile autonomous units for recyclable articles or other items of interest that are important for the operation of waste disposal sites. The controllers recognize items within the image stream(s), based on the library, an image of an item of interest included in the waste materials. The one or more controllers generate instructions for the autonomous mobile units for the identification, collection, and remediation of items of interest.

### TECHNICAL FIELD

The present disclosure relates generally to a waste management system, and more particularly to a waste management system having automated identification, collection, and remediation capabilities for use in storage and waste facility operations.

### BACKGROUND

Municipal waste and recyclable materials are typically collected by waste vehicles. The waste vehicles take waste and recyclable materials to municipal solid waste landfills and recycling facilities for disposal and/or recycling. When recyclable materials are commingled with non-recyclable waste materials like food waste, or are sorted improperly, the resulting contamination substantially increases overall recycling costs, and can turn otherwise valuable recyclable materials into trash. Other valuable materials and objects are also frequently disposed of, or inadvertently combined with, waste products that are then disposed of in landfills. Over time these otherwise valuable materials accumulate in landfills and waste storage facilities, exponentially increasing the volume of waste disposed of in landfills and squandering valuable resources.

Society does not typically take full advantage of reusable materials before disposing of them in landfills. As a result, waste disposal facilities, like municipal landfills and recycling facilities, have the potential to be a ‘new’ source of valuable materials such as scrap metal, electronic components, and other recyclable materials that would otherwise be lost. However, the process of manually identifying and recovering these potentially valuable items at waste facilities, where they have been deposited along with other waste materials, is difficult, dangerous, expensive, laborious, and time intensive. Typically outweighing the potential benefits of doing so. Undetected, valuable items at a municipal solid waste landfill take up space that could otherwise be properly utilized for waste storage, and act as an unrealized potential revenue stream.

Other items of interest also exist in landfill and material storage facilities. Some of these include areas of excessive heat caused by decomposition of organic waste materials, accumulations of volatile gasses, pollutants, improperly disposed of prohibited items, and other items that are difficult to manually identify or respond to. The disclosed system and method are directed to overcome one or more of the problems set forth above, and/or other problems of the prior art.

### SUMMARY

In one aspect, the present disclosure is directed to a system managing the identification, collection, and response to an item of interest in waste disposal sites where offloading of waste by waste vehicles may occur. The system may include a location detection device configured to generate a location signal associated with one or more autonomous mobile units at the disposal site, one or more sensors placed on the one or more autonomous mobile units capable of detecting characteristics indicative of an item of interest, and at least one controller in communication with the sensor detection devices, the location devices, and the one or more autonomous mobile units. The one or more controllers may be configured to correlate the sensors' detection of an item of interest by the autonomous mobile units, and automatically collect or otherwise resolve the item of interest for waste disposal site personnel. The system may also detect locations of site equipment and determine, based on the location, travel avoidance zones for autonomous mobile units. The system may also include automatically detecting the existence of physical hazards at a waste site during operations of autonomous mobile units, and responsively generating operating instructions for the autonomous mobile units.

In another aspect, the present disclosure is directed to a method of managing the identification, collection, and response to an item of interest in waste disposal sites where offloading of waste by waste vehicles may occur. The method may include generation of a location signal associated with one or more autonomous mobile units at the disposal site and recording sensor detection signals indicative of a characteristic of an item of interest disposed of by the waste delivery vehicles at the disposal site. The method may further include correlating the sensors' detections of items of interest by the autonomous mobile units, and automatically collecting or otherwise resolving the item of interest for the waste disposal site personnel. The method may further include detecting locations of site equipment and determining, based on the location, travel avoidance zones for autonomous mobile units in a waste disposal site. The method may also include automatically detecting existing physical hazards at the waste site during the operations of autonomous mobile units, and responsively generating operating instructions for the autonomous mobile units.

In yet another aspect, the present disclosure is directed to a non-transitory computer readable medium containing computer-executable programming instructions for performing a method of managing an item of interest identification, collection and response system for waste disposal sites. The method may include detecting locations of site equipment and determining, based on the location, travel avoidance zones for autonomous mobile units in a waste disposal site. The method may also include automatically detecting the existence of physical hazards at the waste site during operation of autonomous mobile units, and responsively generating operating instructions for the autonomous mobile units.

### BRIEF DESCRIPTION OF THE DRAWINGS

FIG. 1 is an isometric illustration of an exemplary disclosed municipal solid waste landfill or recycling facility environment;

FIG. 2 is a diagrammatic illustration of an exemplary disclosed system that may be used to manage the environment of FIG. 1;

FIG. 3A is an isometric illustration of an exemplary ground-based autonomous mobile unit;

FIG. 3B is an isometric illustration of an exemplary airborne autonomous mobile unit;

FIG. 4 is a top-down illustration of the environment of FIG. 1;

FIG. 5 is a top-down illustration of the environment of FIG. 1 depicting an exemplary overlay of autonomous mobile unit route assignments and zones;

FIGS. 6-10 are flow charts depicting exemplary disclosed methods that may be performed by the system of FIG. 2.

### DETAILED DESCRIPTION

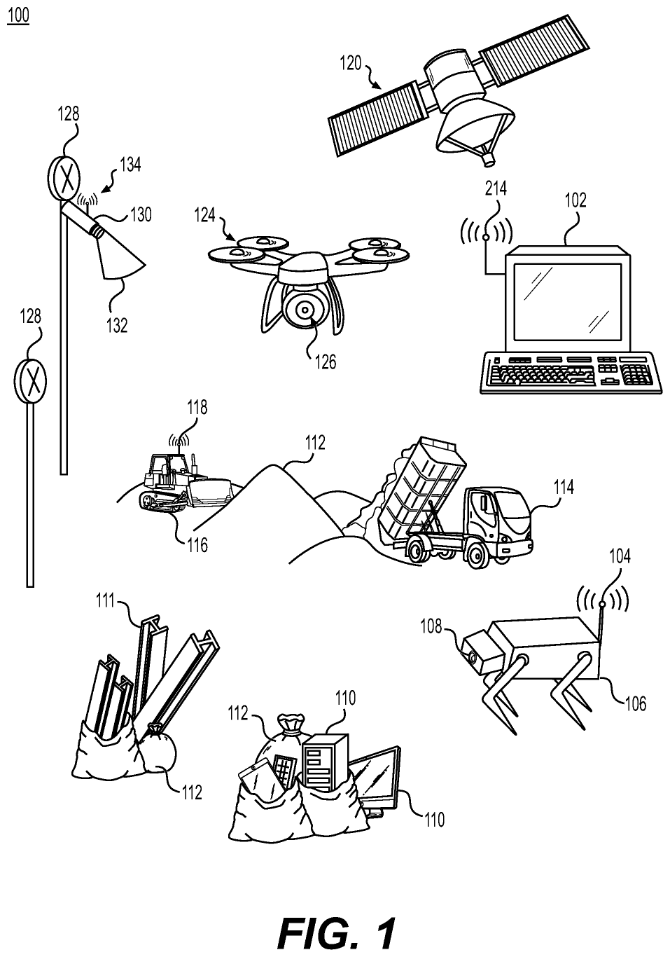

FIG. 1 illustrates an exemplary solid waste facility (“environment”) 100, including an exemplary disclosed assessment and response system (“control system”) 200 to locate, identify, evaluate, measure, collect, and/or remediate potentially valuable/recyclable items, hazardous conditions, prohibited items, or facility operation items (collectively “items of interest”) within environment 100. Environment 100 may be a municipal solid waste landfill, recycling facility, solid waste treatment facility, material recovery facility (MRF), industrial composting facility, material transfer substation, or the like. While described and illustrated in this disclosure with respect to a municipal landfill environment, it will be readily apparent to those skilled in the art that the disclosed system may also be effectively deployed in other environments.

Environment 100 may include deposited waste material 112 delivered to environment 100 by one or more waste vehicle(s) 114. Waste material 112 may include any material transported to, and deposited at, environment 100. Waste material 112 may be manipulated and redistributed within environment 100 by facility equipment (“equipment”) 116. Waste vehicle 114 may take many different forms and may include any type of vehicle that may be used to carry and deliver waste material 112 to environment 100 including, but not limited to, traditional commercial waste haulers, trucks, vans, and the like.

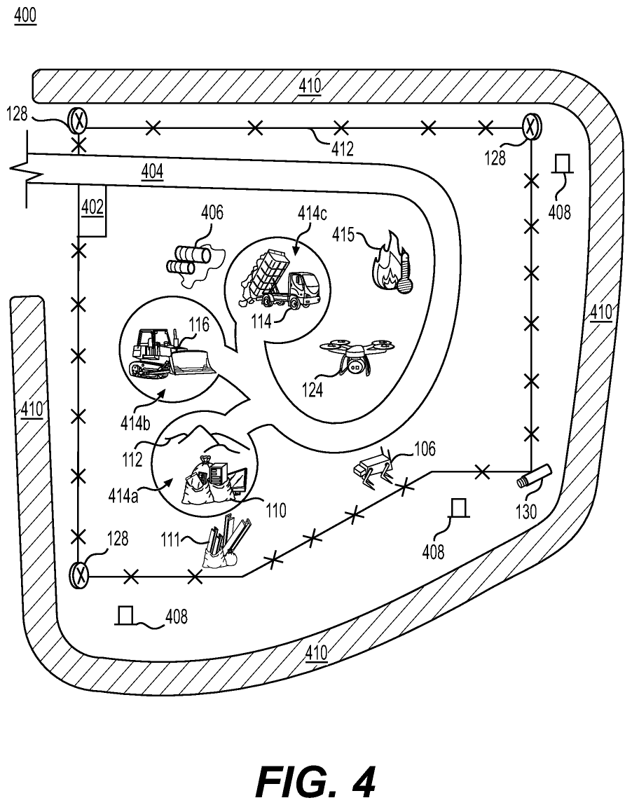

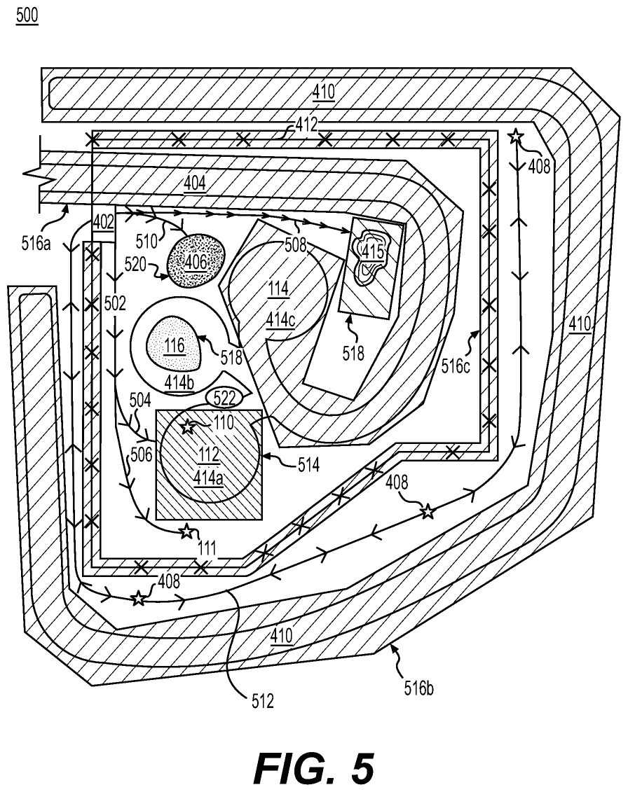

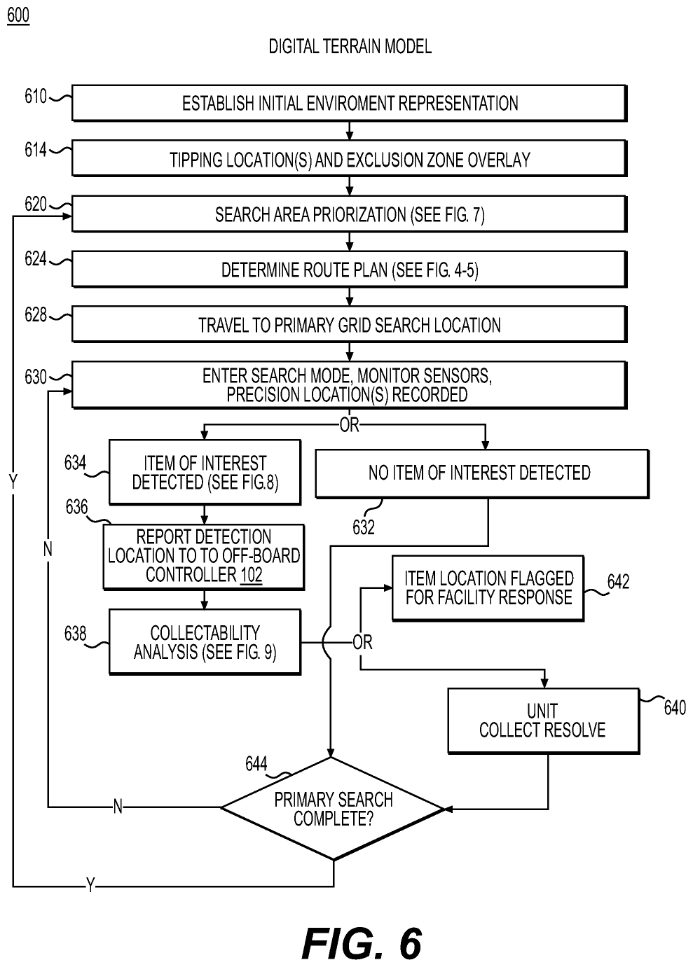

Waste material 112 may contain various items of interest including potentially valuable items (e.g., electronics 110 and metal 111), prohibited item 406 (shown only in FIGS. 4-5), and potential hazard 415 (shown only in FIGS. 4-5). Facility operations item(s) 408 (shown only in FIGS. 4-5), such as monitoring wells, may also be considered items of interest Potentially valuable items may include materials such as electronics 110, metals 111, and recyclable or otherwise reusable materials (not shown) that may be of value if removed from waste material 112 and sold, repurposed, or recycled. Prohibited item 406 may include any material not permitted for disposal within environment 100. For example, flammable or ignitable waste, corrosive waste, toxic waste, industrial waste, biological contaminants and/or infectious waste. A potential hazard(s) 415 may pose a risk to the facility, personnel, equipment, or to environment 100. Potential hazard(s) 415 may, for example, take the form of excessive heat or pockets of dangerous gasses caused by decomposition of waste material 112. In some instances, prohibited item 406 may similarly pose a potential hazard 415.

Facility equipment 116 may include vehicles such as bulldozers, shovel loaders, graders, conveyors, containers, or any other equipment within environment 100 that may pose an obstacle or hazard to autonomous mobile unit 106, 124. For example, as depicted in FIG. 1, equipment 116 may be a bulldozer used to manipulate and redistribute waste material 112.

On-board optical sensor (“camera”) 108, 126 and off-board fixed-location optical sensor(s) (“camera”) 130, could be any type of sensor configured to detect wavelengths of light which could be used by a controller to generate images suitable for an object recognition algorithm that may provide an indication of a potential item of interest.

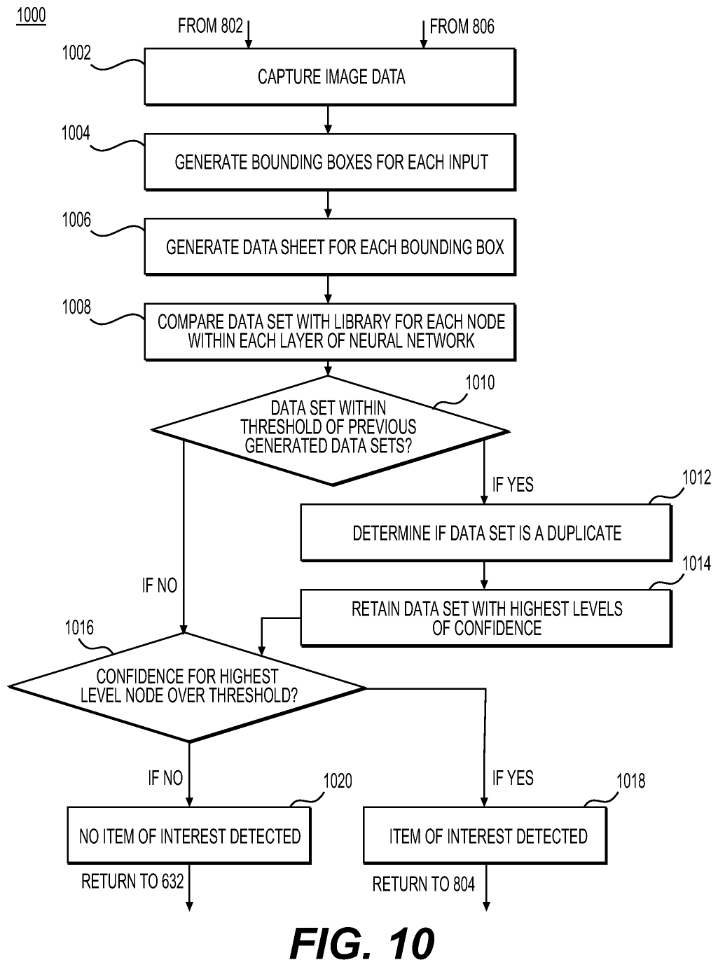

Data and images captured by camera(s) 130, and communicated from transceiver 134, may be processed for object recognition by neural network object identification 1000 (shown only in FIG. 10). Camera 130 may be positioned permanently, or temporarily, at a static location that may be recorded within environment 100. Camera 130 may have a desired vantage point and field of view 132 within environment 100. When a positive detection of an item of interest occurs, the location of the item may be determined by referencing the pre-recorded location of the one or more camera(s) 130, and respective field of view 132, that captured the reading. Camera 130 may be powered directly or may be connected to a power storage battery (not shown). Camera 130 may also include additional sensors to detect and/or identify potential items of interest within waste material 112.

Camera 130 may be able to observe active tipping by waste vehicle 114 or redistribution of waste material 112 by facility equipment 116 in real-time. Camera(s) 130 may therefore be able to identify an item of interest that is later covered by additional waste material 112. Upon receiving a signal from camera 130 indicative of a detected item of interest, control system 200 may log the detected items of interest and may take appropriate action.

Autonomous mobile unit 106, 124 is an unmanned, self-propelled apparatus configured to traverse and scan environment 100 to locate, identify, evaluate, measure, collect, and/or remediate items of interest within environment 100 without direct human guidance. Autonomous mobile unit 106 may be configured to traverse areas of environment 100 that may not be safe for environment personnel, to operate outside of the scheduled and/or operational time or space of facility equipment 116, and to increase the overall efficiency of the operation of environment 100. In one or more embodiments, autonomous mobile unit 106, 124 may be configured to operate within environment 100 without interfering with other operations of environment 100.

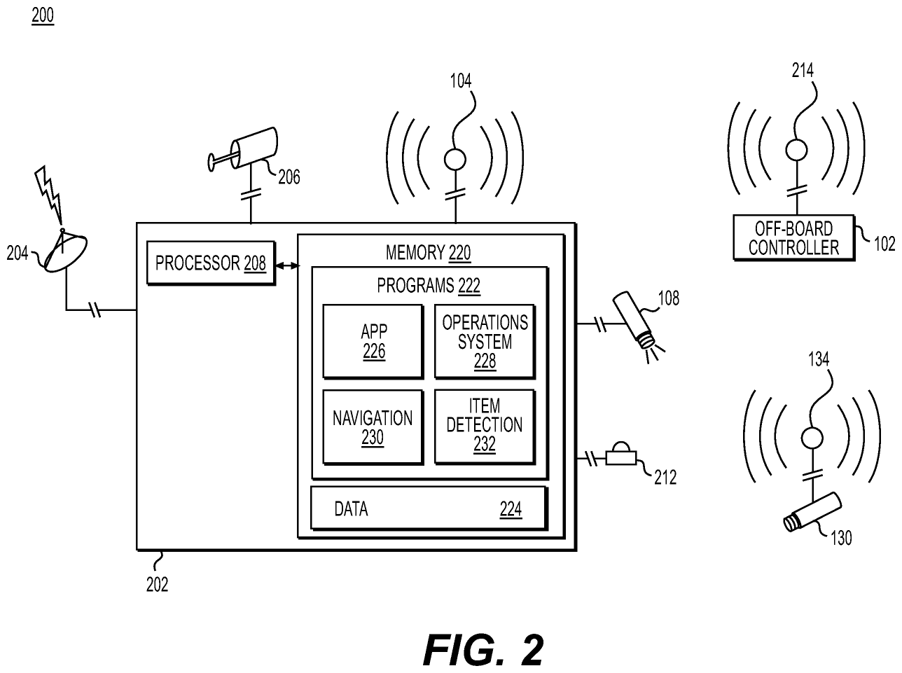

Autonomous mobile unit 106, 124 may include at least one on-board controller 202 (shown in FIG. 2), at least one camera 108, 126, one or more additional sensors 212 (shown in FIG. 2), at least one locator 204 (shown in FIG. 2), and a locomotion system 206 (shown in FIG. 2). The at least one controller schedules and operates all movement and may exist at any computational level (e.g., off-board controller 102, on-board controller 202 (shown in FIG. 2), at a user interface, at one or more servers, online, or distributed across multiple controllers and/or other devices, etc.).

One or more camera 108, 126 may be used to capture images while autonomous mobile unit 106, 124 travels and searches environment 100 to improve navigation, avoid obstacles or dangers, and to identify and/or verify a detected item of interest. As with camera 130 above, object recognition may be accomplished using the data captured by camera 108, 126. Camera 108, 126, and camera 130 may also coordinate traveling and searching activities.

For example, one or more forward-facing camera(s) 108, 124 may be mounted on board autonomous mobile unit 106, 124 oriented to capture images of environment 100 relative to the travel direction of autonomous mobile unit 106, 124. These may include images depicting one or more locations in front and/or to the side of autonomous mobile unit 106, 124. While concurrently one or more fixed-location camera(s) 130 may capture images of autonomous mobile unit 106, 124, waste vehicle 114, and facility equipment 116.

Autonomous mobile unit 106, 124 may include locomotion system 206 (shown in FIG. 2) to traverse environment 100. For example, as illustrated in FIG. 1, autonomous mobile unit 106 is land-based, while autonomous mobile unit 124 may be airborne. Autonomous mobile unit 106, 124 may be configured to traverse environment 100 according to planned, coordinated, user-directed, or fully autonomous routes, and to scan various locations within environment 100 for items of interest (e.g., using one or more of camera(s) 108, 126, and/or sensors 212). Upon detecting an item of interest, autonomous unit 106, 124 may be configured to locate, identify, evaluate, measure, monitor, collect, transport, and/or remediate the detected item of interest.

As autonomous mobile unit 106, 124 moves about environment 100, locator 204 (shown in FIG. 2) may be configured to generate signals indicative of a geographical position, orientation, and/or bearing of autonomous mobile unit 106, 124 relative to a local reference point, a coordinate system associated with environment 100, a coordinate system associated with Earth, or any other type of 2-D or 3-D coordinate system. Based on the signals generated by locator 204 and known kinematics of autonomous mobile unit 106, 124 a position, orientation, bearing, travel speed, and/or acceleration of autonomous mobile unit 106, 124 may be determined. This information may then be sent to on-board controller 202 and/or off-board controller 102, which may use the received data to update the locations and conditions of autonomous mobile unit 106, 124 and/or item(s) of interest in an electronic map or database of environment 100.

For example, locator 204 may embody an electronic receiver configured to communicate with satellites 120, or a local radio or laser transmitting/receiving system (e.g., in conjunction with one or more of fixed location device(s) 128), to determine a relative geographical location of itself. Locator 204 may receive and analyze high-frequency, low-power radio, or laser signals from multiple locations to triangulate a relative 3-D geographical position, orientation, and/or bearing. In some embodiments, locator 204 may include more than one electronic receiver to determine a position, orientation, bearing, travel speed, and/or acceleration of autonomous mobile unit 106, 124 or item of interest. For example, locator 204 may be configured to communicate with GPS satellites 120 while traveling to or from an intended search area, and to communicate with one or more fixed location device(s) 128 while performing activities where greater locational precision is desired (e.g., while scanning a search area, or when determining and/or recording the location of a detected item of interest).

Locator 204, camera(s) 108, 126, 130, and sensor(s) 212 may be considered peripheral devices of a control system 200, which is shown in more detail in FIG. 2. As shown in FIG. 2, control system 200 may additionally include an on-board controller 202, an off-board controller 102, transceivers 104, 134, 214, and locomotion system 206.

On-board controller 202 and off-board controller 102 may include one or more processing devices configured to perform functions of the disclosed methods (e.g., capabilities for monitoring, recording, storing, indexing, processing, communicating, or controlling other on-board and/or off-board devices). As shown in relation to on-board controller 202, on-board controller 202 and off-board controller 102 may include one or more single- or multi-core processor 208, and a memory 220 having stored thereon one or more programs 222, and data 224. Processor 208 may be configured with virtual processing technologies and use logic to simultaneously execute and control any number of operations. Processor 208 may be configured to implement virtual machine or other known technologies to execute, control, run, manipulate, and store any number of software modules, applications, programs, etc.

Memory 220 may be a volatile or non-volatile, magnetic, semiconductor, tape, optical, removable, non-removable, or other type of storage device or tangible (i.e., non-transitory) computer-readable medium that stores computer executable code, such as firmware. Some common forms of machine-readable media may include floppy disk, flexible disk, hard disk, magnetic tape, any other magnetic medium, CD-ROM, any other optical medium, punch cards, paper tape, any other physical medium with patterns of holes, ROM, PROM, EPROM, FLASH-EPROM, any other memory chip or cartridge, and/or any other medium from which a processor or computer is adapted to read. Some common forms of volatile memory include SRAM, DRAM, IRAM, and/or any other type of medium which retains its data while devices are powered, potentially losing the memory when the devices are not powered. Some common forms of memory store computer executable code such as firmware that causes the processor 208 to perform one or more functions associated with data capture, data processing, data storage, data transmitting and/or receiving via transceiver 104, 214. In some embodiments, memory 220 may include one or more buffers for temporarily storing data received from the peripheral devices, before transmitting the data to processor 218.

Programs 222, may include one or more applications 226, an operating system 228, navigation system 230, and an item detection system 232. Application 226 may cause control system 200 to perform processes related to generating, transmitting, storing, and receiving data in association with search areas and items of interest within environment 100. For example, application 226 may be able to configure control system 200 to perform operations including: navigation and searching for items of interest within environment 100 using navigation system 230, capturing photographic and/or video data associated with detected items of interest; capturing location data associated with items of interest, a location of autonomous mobile unit 106, 124, and/or a location of a detected item of interest; processing control instructions; sending the photographic and/or video data, the location data, and the instructions to another location (e.g., to a back office); receiving data and instructions from the other locations; coordinating operations of a plurality of autonomous mobile units 106, 124; and collecting and/or remediating detected items of interest.

Operating system 228 may perform known functions when executed by processor 218. By way of example, the operating system may include Microsoft Windows®, Unix®, Linux®, Apple® operating systems, Personal Digital Assistant (PDA) type operating systems, such as Microsoft CE®, or another type of operating system. Control system 200 may also include communication software that, when executed by processor 208, provides communications with an external network, such as web browser software, tablet, or smart handheld device networking software, etc.

Navigation system 230 may cause control system 200 to establish an electronic representation of environment 100 within which autonomous mobile unit 106, 124 is to operate, select a search area within which autonomous mobile unit 106, 124 is to search for items of interest, route autonomous mobile unit 106, 124 to the selected search area, and send instructions to locomotion system 206 to traverse, search, or otherwise interact with environment 100. Item detection system 232 may cause control system 200 to activate and/or monitor one or more of camera 108, 126, 130, and sensors 212 to identify items of interest within environment 100.

Peripheral devices (e.g., camera(s) 108, 126, 130; sensor(s) 212; locator 204; artificial lighting, and other devices) may be standalone devices or devices that are mounted onboard autonomous mobile unit 106, 124. The peripheral devices may themselves include one or more processors 208, memory 220, and transceiver 104, 134, 214. It is contemplated that autonomous mobile units 106, 124 may include additional or fewer components, depending on the intended capabilities of the autonomous mobile unit 106, 124, the number of autonomous mobile units 106, 124, and the type of control system 200.

Transceiver 104, 134, 214 may be configured to transmit information to, and/or receive information from, on-board and/or off-board components of control system 200 (e.g., on-board controller 202, off-board controller 102, peripheral device(s), a user device, and/or back office, etc.). Transceiver 104, 134, 214 may include a wired or wireless communication module capable of sending data to, and receiving data from, one or more components in control system 200 via a local network and/or another communication link.

In some embodiments, transceiver 104 may receive signals from off-board controller 102, including instructions for processor 208 to activate peripheral devices and locomotion 206, record data to onboard memory 220, or transmit data directly to one or more off-board components. For example, activation of one or more peripheral devices to capture video/image/sensor/location data may occur in response to a signal received by transceiver 104. Processor 208 may then process, store, and/or transmit the captured data to on-board memory 220 or off-board controller 102.

Autonomous mobile unit 106, 124 may in this way communicate with another autonomous mobile unit 106, 124, send and receive data and instructions with off-board controller 102, and/or receive data about environment 100 from off-board sensor(s) 130. They may further communicate with a user interface or other off-board devices, which may be located, for example, on facility equipment 116 in communication through transceiver 118.

Control system 200 may further incorporate the information gained through this communication to navigate autonomous mobile unit 106, 124 safely through environment 100 to and from search areas and/or items of interest. On-board controller 202, and off-board controller 102 may operate independently or in concert, and may be configured to track, assist, and control movements or operations of autonomous mobile unit 106, 124, and/or to manage the current or future operations of autonomous mobile unit 106, 124.

Peripheral devices (e.g., camera(s) 108, sensor(s) 212, locator 204, artificial lighting, and other devices) may be standalone devices or devices embedded within control system 200. Peripheral devices may themselves include one or more of a processor, memory, and transceiver. It is contemplated that the peripheral device can include additional or fewer components, depending on a type of control system 200.

Locomotion system 206 may include one or more systems or methods by which autonomous mobile unit 106, 124 may traverse or interact with environment 100, including one or more of electric motors, solenoids, hydraulic components, pneumatic components and the like. Autonomous mobile unit 106, 124 may employ locomotion system 206 to traverse environment 100 by one or more methods suitable to locomotion within environment 100 such as, for example, walking, rolling, hopping, slithering, metachronal motion, flight, and/or any combination or hybrid mode thereof.

Control system 200 may be configured to utilize a plurality of cameras 108, 126, 130 and/or locators 204 to determine one or more characteristics of a detected item of interest. For example, control system 200 may include one or more off-board fixed-location optical sensors (“camera”) 130, and may be configured to determine one or more characteristics of a detected item of interest within the respective fields of view 132 of a plurality of cameras 130. For example, using the known fixed locations of a plurality of cameras 130 combined with the measured sizes of a detected item of interest within the field of view 132 of each of a plurality of cameras 130, control system 200 may determine the precise location and/or size of said item of interest Additionally, where one or more location device(s) 128 are within the field of view 132 of camera 108, 126, 130, the known fixed location of identified location device 128 may be used in conjunction with the known location of camera 108, 126, 130 to determine one or more of an exact location, size, area, intensity, or weight of a detected item of interest within field of view 132 of camera 108, 126, 130.

Similarly, with fixed location device 128 in three or more locations, control system 200 may be configured to incorporate triangulation data generated with a laser positioning system (locator 204) from autonomous mobile unit 106, 124 to determine the exact size and location of a detected item of interest. In one embodiment, autonomous mobile unit 106, 124 may be configured to navigate to and initially detect an item of interest using GPS location coordinates and may improve upon the initially detected GPS location of the item of interest using laser triangulation.

For example, autonomous mobile unit 106, 124 may be configured to use GPS signals while navigating to an assigned search area, and to use the laser positioning system enabled by fixed location device(s) 128 while scanning the assigned search area for items of interest. Alternatively, a laser positioning system may be activated only when an item of interest is detected. GPS location systems typically use less power than laser positioning systems but are less precise. Therefore, using dual location systems in this manner may provide power savings while operating the GPS, and increased precision while operating the laser positioning system. Precision locations may be particularly helpful by identifying the precise location of an item of interest where autonomous mobile unit 106, 124 is unable to collect or remediate a detected item of interest, such as when a large item of interest requires the use of facility equipment 116 to affect collection or remediation.

As discussed previously, camera 108, 126 may form a portion of control system 200 and may be configured to track, scan, identify, and potentially remediate items of interest commingled with waste material 112. Autonomous mobile unit 106, 124 may include one or more cameras 108, 126 and one or more additional sensor(s) 212 configured to detect an item of interest 110, 111, 406, and/or 408 while traveling and searching within environment 100, including within an assigned search area 514 (shown in FIG. 5).

At least two categories of sensors may be deposited on-board autonomous mobile unit 106, 124 including peripheral sensors and sensors 212. Peripheral sensors (not shown) may be configured to generate one or more signals indicative of an operational function of autonomous mobile unit 106, 124. For example, peripheral sensors may include sensors configured to generate signals indicative of a distance to a detected object or item interest, or that assist autonomous mobile unit 106, 124 in other functions. Pressure sensors, proximity sensors, touch sensors, strain gages, accelerometers, ultrasonic sensors, and 3D orientation sensors such as levels are a non-exhaustive list of potential peripheral sensors.

Sensor(s) 212 may be configured to generate a signal indicative of the presence or attribute(s) of an item of interest in the vicinity of autonomous mobile unit 106, 124. For example, sensor(s) 212 may include one or more of the physical sensor types identified in Table I below.

TABLE I

| Sensor Type | Attribute Detected | Function |
|---|---|---|
| Magnetometer | Measures a magnetic field or | May be used to detect magnetic |
| | magnetic dipole moment. | metals, and may detect metals |
| | Different types of magnetometers | at greater distances than |
| | measure the direction, strength, | conductivity metal detectors |
| | or relative change of a magnetic | |
| | field at a particular location | |
| Conductivity metal | Measures electrical conductivity | May be used to detect items |
| detector | of metals over short distances | composed of iron, steel, copper, |
| | | copper alloys, gold, silver, |
| | | and any other conductive metal |
| | | other than aluminum, titanium, |
| | | and other metals of insufficiently |
| | | low conductivity |
| Radiation sensor | Measures radiation | May be used to detect radioactive |
| | characterized by a type or | materials, potentially from |
| | functionality of radiation | prohibited items such as smoke |
| | including counters, | detectors and medical equipment |
| | spectrometers, and radiation | |
| | dosimeters | |
| Temperature sensors and | Measures air temperature, | May be used to identify potential |
| infrared radiation (IR) | liquid temperature, or | areas of excessive heat from |
| sensor | temperature of solid matter. | decomposition or other sources |
| | Some examples include | |
| | thermocouples, resistance | |
| | temperature detectors, | |
| | thermistors, semiconductor | |
| | based integrated circuits | |
| | and infrared cameras | |
| Air particle sensor | Dust and particulate | May be used to monitor air quality, |
| | measurement sensors used | detect items of interest including |
| | to measure the concentration | prohibited items having toxic chemical |
| | and/or size of particles in | signatures, and to monitor environmental |
| | the air | dust quantities or contamination |

Sensor(s) 212 may also include one or more chemical sensors, which may provide information about the chemical composition of liquid or vapor in environment 100. Different types of chemical sensors may be configured to deduce concentration, chemical activity, and/or the presence of metal ions or gasses including concentrations of flammable, explosive, or toxic gasses and environmental pollution.

Chemical sensors may take different forms depending upon the underlying principle used to detect an analyte. Common examples include electrochemical, mass, optical, magnetic, and thermal sensors. For example, a mass sensor may be used to detect changes in mass induced by adsorption of mass by an analyte. Similarly, an optical chemical sensor may be used to detect changes in optical properties, which may result from the interaction of the analyte and a receptor. A magnetic chemical sensor may detect changes in magnetic properties caused by analyte adsorption. A thermal sensor detects thermal effects that may be generated by specific chemical reactions or adsorption processes between analyte and a receptor surface.

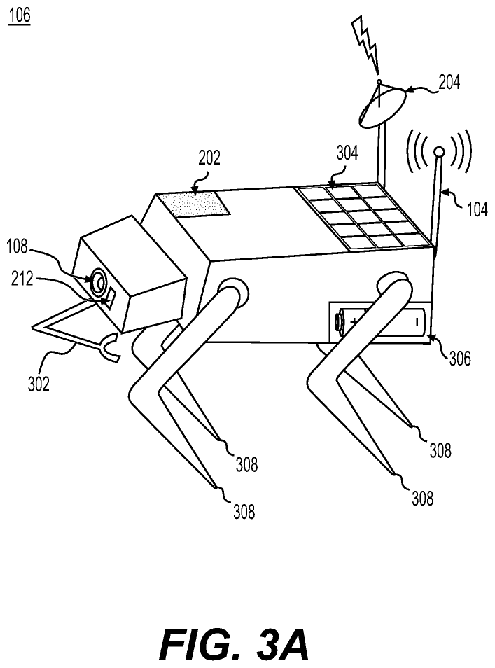

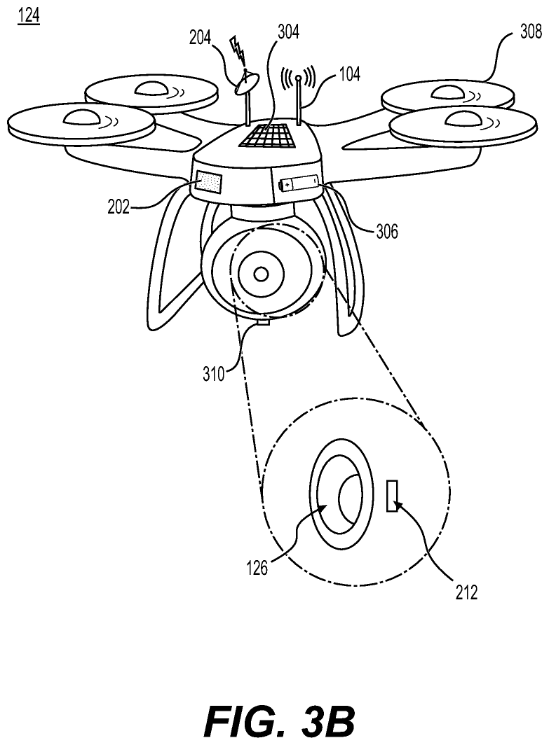

FIG. 3A depicts a land-based autonomous mobile unit 106. Autonomous mobile unit 106 may include an on-board controller 202, communicatively connected to locator 204, transceiver 104, camera 108, and one or more sensor(s) 212. Travel mechanism 308 and manipulation mechanism 302 are components of locomotion system 206, which provides primary travel and manipulation functions of autonomous unit 106. Autonomous mobile unit 106 may also include one or more on-board power storage (“battery”) 306 and solar panel 304.

Battery 306 may take the form of any battery or battery bank capable of powering autonomous mobile unit 106 operations within environment 100. Battery 306 may readily be charged from other power sources. For example, where equipped, solar panel 304 may provide a source of power for autonomous unit 106 while it traverses environment 100. Those skilled in the art will appreciate that other means of power charging may be used to charge battery 306 and/or to power autonomous mobile unit 106.

Travel mechanism 308 of autonomous mobile unit 106 may include various travel modalities. For example, as shown in FIG. 1, autonomous mobile unit 106 is configured to navigate environment 100 by operating one or more mechanical articulating components. In an alternative embodiment, autonomous mobile unit 106 may use wheels, wheel-driven tracks, or other means of locomotion to navigate environment 100.

Manipulation mechanism 302 may be utilized by autonomous mobile unit 106 to physically interact with environment 100. Manipulation mechanism 302 may take different forms depending on its intended purpose. For example, as illustrated in FIG. 3A, manipulation mechanism 302 may comprise a mechanically driven articulated component enabling autonomous mobile unit 106 to grasp and collect, rotate, shift, move, and/or transport various items within environment 100 including items of interest. In one embodiment autonomous unit 106 may be configured to use manipulation mechanism 302 to grasp an item of interest and then carry or drag it to a designated collection location or staging area. In one or more embodiments, autonomous mobile unit 106 may include a collection port (not shown) where manipulation mechanism 302 may place and store one or more items of interest while continuing to search environment 100 for additional items of interest and/or for the duration of operations. Any stored items of interest may then be unloaded and deposited at a collection or staging location.

As illustrated in FIG. 3B, autonomous mobile unit 124, includes similar components to autonomous mobile unit 106. In contrast to land-based autonomous mobile unit 106, however, travel mechanism 308 of mobile unit 124 may comprise any number of propellers or other travel mechanism enabling airborne navigation within environment 100. Locator 204 of autonomous mobile unit 124 may further integrate peripheral sensors (not shown) such as an altimeter, accelerometer(s), or any other sensor configured to generate signals indicative of altitude, airspeed, and/or airborne attitude and orientation during airborne travel. On-board controller 202 may monitor signals received from these peripheral sensors and may control travel mechanism 308 achieve and maintain a desired position, attitude, trajectory, and/or flight stability of autonomous mobile unit 124. Autonomous mobile unit 124 may also be configured to interact with environment 100 using one or more manipulation mechanisms 302 (not shown). In one or more embodiments, autonomous mobile unit 106, 124 may further include a power charging port 310 (shown only in FIG. 3B) to allow direct charging of battery 306.

FIG. 4 is a top-down illustration or map of environment 100, facility environment 400. Autonomous mobile unit 106, 124 may be configured to navigate environment 100 to avoid both static and dynamic obstacles or hazards. Static obstacles or hazards are those that are not reasonably expected to not change in nature, location, or activity during the operation of autonomous mobile unit 106, 124. Examples of static obstacles may include buildings, towers, or other structures; fixed equipment such as conveyors, lighting, fencing, power lines, etc.; and potentially hazardous terrain or features such a steep runoff control ditch, active roadway, etc. Control system 200 may be configured to identify and account for such static obstacles and hazards once during a given travel and/or search cycle or operation. Dynamic obstacles or hazards are those that may be expected to change in nature or location over such a short interval of time that control system 200 may be configured to monitor, account for, and respond or adjust the operation, travel path, and/or selected search area of autonomous mobile unit 106, 124 in real time, near real-time, or at least each time a route is determined by control system 200. Examples of dynamic obstacles or hazards may include mobile or operating facility equipment 116, waste vehicles 114, etc. Control system 200 may be configured to identify and respond to static and/or dynamic obstacles or hazards actively (e.g., through object detection using camera 108), and/or based on received information (e.g., through identified map or database information or based on information received from other sources such as fixed-location camera 130, information provided by other autonomous mobile units 106, 124, or recorded location information of facility equipment 116 or other autonomous mobile units 106, 124).

Autonomous mobile unit 106, 124 may be configured to avoid different obstacles and hazards according to its known capabilities and limitations. For example, ground-based autonomous mobile unit 106 may be configured to avoid static obstacles such as runoff control ditch 410, fence line 412, and active roadway 404, while autonomous mobile unit 124 may be required to maintain a minimum altitude while traversing or searching the same obstacles. Similarly, autonomous mobile unit 106 may be configured to avoid dynamic hazards such as active spreading site 414b, facility equipment 116, active disposal site 414c, and waste vehicle 114. Autonomous mobile unit 124, by contrast, may be configured to enter, traverse, and/or search active spreading site 414b and/or active disposal site 414c to detect and identify potential items of interest while waste material 112 is redistributed or deposited while also maintaining a minimum distance from facility equipment 116 and/or waste vehicle 114. Such limitations serve to protect autonomous mobile unit 106, 124 from damage and to avoid interfering with ongoing facility operations.

Prohibited item 406 and excessive heat hazard 415 constitute examples of items that may be simultaneously classified as items of interest as well as dynamic hazards. Prohibited item 406, excessive heat hazard 415, plant operation item(s) 408, valuable electronics 110, and valuable metals 111 are examples of potential items of interest that may be found in environment 100. Items of interest may be found virtually anywhere within environment 100 including, for example, within established tipping and treatment sites 414a-c, within another selected search area, along a selected travel path, or while otherwise traveling to or from a selected search area.

As described above, active spreading site 414b, and active disposal site 414c, may be simultaneously defined as potential hazards as well as prioritized search areas. When a particular geographical area is defined as both a prioritized search area and potential hazard, control system 200 may be configured to prevent or allow autonomous mobile unit 106, 124 to traverse or otherwise operate within such areas depending on the travel capabilities of the particular autonomous mobile unit 106, 124. For example, if spreading is occurring within active spreading site 414b, airborne autonomous mobile unit 124 may be permitted to travel or search for items of interest within the area while ground-based autonomous mobile unit 106 may be prohibited from entering the same area. In some instances, airborne mobile unit 124 may be required to maintain a minimum altitude while operating within a geographic area defined as a potential hazard or obstacle (e.g., 25 ft.) to ensure that it does not interfere with active plant operations and/or result in damage to itself, personnel, facility equipment 116, etc.

As shown in FIG. 4, environment 100 may further include an autonomous mobile unit staging area (“staging area”) 402. Staging area 402 may include a location to charge autonomous units 106, 124, via charging port 310. Additionally, in some embodiments, autonomous mobile unit 106, 124 may utilize staging area 402 as a delivery or collection site for items of interest, a storage area for mobile units, and/or repair/service location. In some instances, staging area 402 may act as a location where collected data may be transmitted by wired or wireless means from on-board controller 202, to a back office such as offboard controller 102. Control system 200 may incorporate information about environment 100 from one or more of fixed-location camera 130, camera 108, 126, sensor(s) 212, and any additional information about environment 100 that may be manually entered or automatically determined or received to safely route autonomous mobile unit 106, 124 from staging area 402 to a selected prioritized search location.

Environment 100 may include one or more established tipping and treatment sites 414a-c that are utilized simultaneously for different phases of waste disposal and treatment according to a schedule or as otherwise desired to optimize land use and operations within environment 100. Although FIGS. 4-5 only illustrate established tipping and treatment sites 414a-c, any number of sites may be initially or subsequently established as may be appropriate at a given facility. Similarly, one or more of established tipping and treatment sites 414a-c may be decommissioned or otherwise removed from use as desired. Roadways to established sites may be created, rerouted, and/or decommissioned as appropriate. One possible schedule or cycle for using and rotating a particular treatment site 414a-c may include the following: 1) waste material 112 is actively deposited by waste vehicle(s) 114 (e.g., active disposal site 414c); 2) site is deactivated as an active tipping location and tipped waste material 112 remains fallow to allow for settling and decomposition, etc. (e.g., fallow waste site 414a); 3) tipped waste material 112 is redistributed and/or sorted by facility equipment 116 (e.g., active spreading site 414b); 4) waste material 112 is covered, treated, and/or recycled (not shown); and 5) active tipping of waste is re-established at site. Control system 200 may receive one or more signals indicative of a scheduled use of established tipping and treatment sites 414a-c. Information including one or more of location coordinates, a date, time, and status of one or more established tipping and treatment sites 414a-c may be received by control system 200. The received date and/or time information may include a start-time, an end-time, or duration of scheduled use. The received location coordinates may be defined by a set of coordinates defining a perimeter of established tipping and treatment sites 414a-c, a particular coordinate defining the center of an established tipping and treatment site 414a-c, or any other spatial coordinate system.

Autonomous mobile unit 106, 124 may scan a particular established tipping and treatment site 414a-c for items of interest during various stages of the planned use of the site. Advantageously, scanning operations may be scheduled or otherwise carried out so as not to impede or delay active tipping of waste material 112 by waste vehicle(s) 114 or operations of facility equipment 116. For example, autonomous mobile unit 106, 124 may be dispatched to search a particular established tipping and treatment site 414a-c between scheduled stages or cycles for using and rotating a particular established tipping and treatment site 414a-c, or while waste material 112 remains fallow after tipping (e.g., at fallow waste site 414a).

FIG. 5 is a top-down isometric illustration of an autonomous unit route planning environment overlay (“overlay”) 500 of facility environment 400. Control system 200 may be configured to establish one or more types of travel exclusion zones based on the detection of static hazards and/or dynamic hazards. Exclusion zones may take the form of a geographically delineated area within any coordinate system previously mentioned, where travel may be restricted for one or more autonomous mobile units 106, 124. Because different autonomous mobile units 106, 124 may have different capabilities, different travel restrictions within an exclusion zone may be applied for each type of autonomous mobile unit 106, 124. For example, to search for, collect, or remediate an item of interest, control system 200 may be configured to establish travel routes and/or selected search areas that account for flight or ground travel restrictions of exclusion zone 516a-c, and facility equipment exclusion zone 518.

Control system 200 may be configured to select one or more travel route(s) 502-512 and/or search areas 514, 524 based on any number of factors. For example, the known rotation of established tipping and treatment sites 414a-c may be selected to allow for scanning activities to occur at times when items of interest are most likely to be encountered, such as while waste material 112 is tipped at active disposal site 414c (or soon thereafter), while waste material 112 remains fallow at fallow waste site 414a, or while waste material 112 is redistributed at active spreading area 414b (or soon thereafter). Control system 200 may be configured to select one or more priority search areas 514 to increase the likelihood of detecting an item of interest within waste material 112. For example, priority search area 514 encompasses fallow waste site 414a. The priority level of a search area may also account for the existence or overlap of exclusion zones and/or the capabilities of a specific autonomous mobile unit 106, 124. Control system 200 may also be configured to prioritize a search zone upon recording or detecting a change in status from an exclusion zone. For example, control system 200 may be configured to prioritize a search zone covering active disposal site 414c when the area is no longer covered by exclusion zone 516a to prioritize searching for items of interest in freshly available waste material 112. Similarly, control system 200 may prioritize a search zone covering facility active spreading site 414b once the area no longer coincides with facility equipment exclusion zone 518. Similarly, the priority level of a search area may account for prior detections of an item of interest.

Based on schedules and overlays of exclusion zones and/or priority search areas, control system 200 may direct or control autonomous mobile unit 106, 124 along one or more paths (“routes”) 502, 504, 506, 508, 510, 512 to a selected location or search area within environment 100. Upon reaching a designated location, control system 200 may direct or control autonomous mobile unit 106, 124 to perform one or more desired tasks including searching for items of interest, collecting items of interest, remediating prohibited items, or reporting detected items of interest to a back office or other personnel.

Upon selecting a destination (e.g., priority search area 514, search area 524, detected item of interest 111, potential contamination area 520, facility operation items 408, etc.), control system 200 may direct or control ground-based autonomous mobile unit 106 to traverse environment 100 to the selected destination according to one or more of routes 502, 504, 506, 508, 510, and/or 512, avoiding exclusion zones 516a-c. In some embodiments ground-based autonomous mobile unit 106 may travel to a selected destination using one or more dedicated autonomous mobile unit travel routes (“dedicated route”) 502, 504, 512. Dedicated route 502, 512 may be an established travel path to one or more routinely selected destinations. For example, route 512 may be a dedicated route used by autonomous mobile unit 106 to routinely observe and/or access monitoring wells and/or other facility operation items 408. Route 502 may be a dedicated route used to travel along fence line 412, from which established tipping and treatment sites 414a-b may be routinely accessed, including a branch to dedicated path 504 leading to priority search area 514. Where no dedicated route to a selected destination exists, control system 200 may be configured to direct or control ground-based autonomous mobile unit 106 along a navigated route. Navigated routes may be determined prior to travel (e.g., based on the shortest distance to a selected destination while avoiding exclusion zones, static and dynamic obstacles/hazards, and terrain accessibility), or may be determined by control system 200 as ground-based autonomous mobile unit 106 travels to a selected destination. Routes 506, 508, and 510 may be either dedicated routes or navigated routes. In the example illustrated in FIG. 5, route 504 may be used to dispatch autonomous mobile unit 106 to priority search area 514. Similarly, autonomous mobile unit 106 may access previously detected metal 111 via route 506, search area 518 via route 508, and potential contamination exclusion area 520 via route 510.

Airborne autonomous mobile unit 124 may travel to a selected location by similarly traveling along routes 502, 504, 506, 508, 510, and/or 512, or alternatively by direct or alternative routes while maintaining sufficient altitude required while traversing exclusion zones 516a-c, 518. Airborne autonomous mobile unit 124 may also search established tipping and treatment sites 414b-c despite exclusion zone 518, 516a by maintaining the minimum altitude requirements of each exclusion zone, or may alternatively operate from outside an exclusion zone to search for and detect items of interest within them.

Based on data transmitted by facility equipment transceiver 118, and based on known kinematics of facility equipment 116, a position, orientation, bearing, travel speed, and/or acceleration of facility equipment 116 may be used to determine exclusion zone 518. Exclusion zone 116 may be defined based on a radius or distance from the position of facility equipment 116 and may optionally be adjusted in light of an orientation, bearing, travel speed, and/or acceleration of facility equipment 116. Autonomous mobile unit 106, 124 may also be configured to detect and avoid obstacles and hazards not that are not otherwise previously known or reported to control system 200, such as active waste vehicle 114. In one embodiment, control system 200 may be configured to track changes to environment 100 by recording and analyzing location data from locator 204 and locomotion data from 206. For example, changes in elevation may be detected by locator 204 compared to previously recorded location and or travel data.

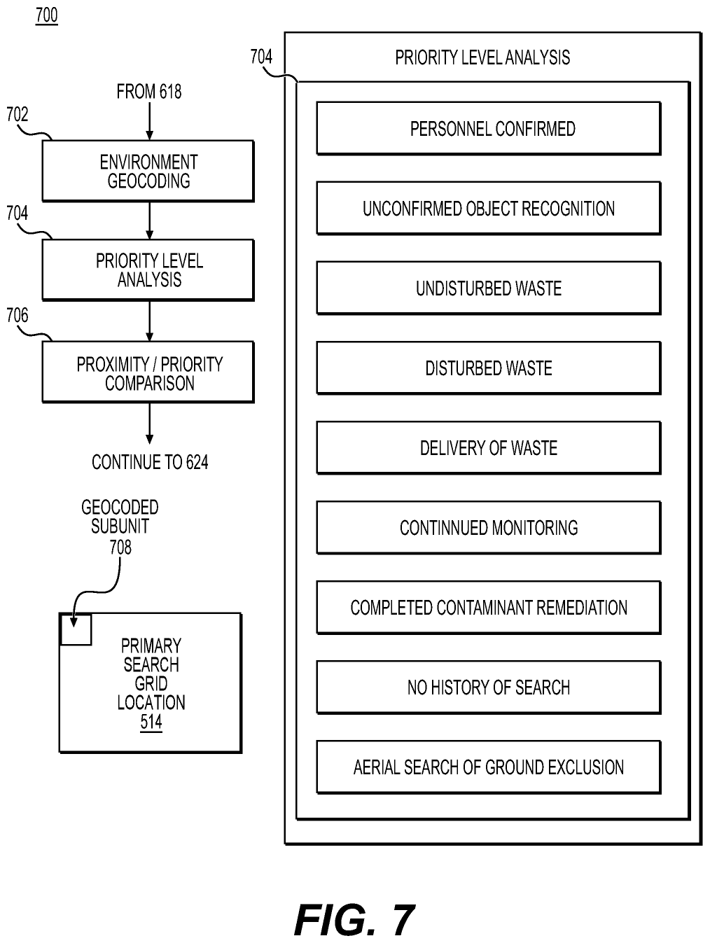

A user interface (“UI”) (not shown) may be included on-site or in any remote location. Off-board controller 102 or any other controller(s) may transmit data to, and/or receive instructions from the UI, as it may also be implemented via smartphone, tablet, or any other device capable of sending instructions to another location (to a back office and/or a customer) and receiving data and instructions from control system 200. In one example, a UI may be placed on facility equipment 116 to flag an area 710 (shown only in FIG. 7) for potential items of interest observed by facility operators.

Exemplary processes performed by control system 200 are illustrated in FIGS. 6-10. These processes will be explained in more detail in the following section to further illustrate the disclosed concepts.

### INDUSTRIAL APPLICABILITY

The disclosed system may be applicable to a municipal solid waste landfill, recycling facility, solid waste treatment facility, material recovery facility (MRF), industrial composting facility, material transfer substation, or the like, to identify and recover potentially valuable items from waste facilities where they are deposited along with other waste materials making isolation difficult, dangerous, expensive, laborious, and/or time intensive, typically outweighing the potential benefits of doing so. The disclosed system may be able to automatically monitor and control the movement of autonomous mobile units within an environment to detect and identify items of interest, record their location, and/or collect or remediate the item of interest. Operation of control system 200 will now be described with reference to FIGS. 6-10.

As seen in FIG. 6, upon initialization of an autonomous mobile unit 106, 124, control system 200 may begin the disclosed method by establishing an initial electronic representation 500 of environment 100 within which autonomous mobile unit 106, 124 is to operate (Step 610). The electronic representation of environment 100 may include geographical coordinates defining the perimeter of environment 100 and the capabilities of autonomous mobile unit 106, 124 boundary of environment 100 and outer limit of operation of AMU 106, 124. The area of environment 100 and any of the locations therein may be defined as a geographical area relative to a local reference point or points (e.g., one or more location device 128 and/or autonomous mobile unit staging area 402), a coordinate system associated with environment 100, a coordinate system associated with Earth, or any other type of 2-D or 3-D coordinate system. The data imported at this stage may be stored within on-board controller 202 or off-board controller 102, received from a public or proprietary geographic information system (GIS), determined automatically based on GPS and/or satellite imagery, based on sensor data collected automatically (i.e., from autonomous mobile units 106, 124, equipment 116, etc.), and/or manually entered (e.g., at back-office controller 102).

Initial electronic representation 500 of environment 100 may further include topographical information such as contour lines and/or elevation data, the location and/or dimensions of one or more static physical hazards, and/or altitude levels necessary for airborne autonomous mobile unit 124 to clear a static physical hazard. Data about the locations and dimensions of operational elements within environment 100 such as location device 128, established tipping and treatment sites 414a-c, dedicated route 502, and/or recurring sampling route 512 may also be populated at this stage. Data about these static elements may not change in nature or location over such a short interval of time to require being accounted for separately each time a route is determined by control system 200.

In some embodiments, initial electronic representation 500 of environment 100 may further include traversability estimations and semantic terrain classifications, which may take into account type of travel (ground-based and wheeled, articulated, track-based, or air-born, etc.). For example, control system 200 may develop semantic terrain classifications may be made by comparing expected conditions with the capabilities of autonomous mobile units. These estimates or classifications may be further delineated by the particular unit that the estimations are made for, and/or the degree of difficulty a unit may encounter. For example, if the runoff ditch 410 has a change in grade beyond the ground traversing operational parameters of autonomous mobile unit 106 the area thereof may be classified as non-traversable by autonomous unit 106, but not for an air-born autonomous unit 124. This information may be used later by control system 200 to establish exclusion zones (Step 614). Similarly, static hazards such as fence line 412 may be coded as an obstacle with geographic parameters that may impact the travel of any autonomous mobile unit 106, 124.

Location(s) of established tipping and treatment site(s) 414a-c may be received by controller 102 during Step 614 as the locations of tipping and treatment site(s) 414a-c are unlikely to change a single operational cycle. Established tipping and treatment site(s) 414a-c are geographic areas where waste is actively delivered, will be delivered, or has been delivered previously.

Controller 102 may use data received by during Step 614 to establish one or more exclusion zone overlays. For example, controller 102 may be configured to receive one or more signals indicative of the nature and location of static obstacles at this stage. Information regarding static obstacles may also be updated over time through sensory recordings by autonomous units, through manual updates by personnel, or by other means at any interval. Controller 102 may also be configured to receive one or more signals indicative of data concerning waste delivery scheduling during Step 614. Some examples of such information may include the number of locations where waste is actively being delivered to in environment 100, schedules of waste deliveries, schedules of tipping locations or roadway activity, and identification of equipment that may be functioning in coordination with waste delivery activities.

Exclusion zones prevent autonomous mobile units from being damaged or impeding waste delivery operations. Static obstacles may impose constant constraints to navigation whereas exclusion zones may have multiple characteristics, sizes and/or durations that may act as variables in the computation of navigation routes. Exclusion zones can be geometric shapes (e.g., a circle, a polygon, a line, etc.) that passes through each coordinate that defines an exclusion zone, defined by a radius from a given coordinate, etc. Exclusion zones may be defined in two dimensions for ground based autonomous mobile units 108, or in three dimensions including elevation requirements for airborne autonomous mobile units 124. Exclusion zones may also have different characteristics which may apply to different autonomous units. The duration of time the exclusion zone is in effect may be of any length or may repeat.

For example, control system 200 may establish exclusion zone 516a based on location information identifying active roadway 404, location information identifying active disposal site 414c, and information about scheduled or detected use of active disposal site 414c. Control system 200 may be further configured to establish a schedule for exclusion zone 516a based on received schedule information as to days and times when waste vehicle 114 is permitted to travel on active roadway 404 and/or offload waste materials at disposal site 414c. In one or more embodiments one or more of exclusion zones 516a-c and exclusion zones 414a-c may only apply to certain types of autonomous mobile units based on the capabilities of each particular unit. For example, exclusion zone 516b may only apply to only ground units, because airborne units need not be concerned with steep grade changes as may define the drainage ditch 410. Similarly, exclusion zone 516a may only apply to ground units, or may include a minimum altitude restriction on airborne units traveling within the exclusion zone.

Exclusion zones for facility equipment 116 may be established based on the particular facility equipment properties. The equipment may be deemed to be operational in a tipping site based on a location and schedule (as with the example of waste delivery activities of active disposal site 414c resulting in that part of exclusion zone 516a). It may also be established in step 614 through the incorporation of equipment locational and kinematic data as in exclusion zone 518. Controller 102 may use data transmitted by equipment transceiver 118 and equipment kinematics received from a memory, sensors, or any other source, a position, orientation, bearing, travel speed, and/or acceleration of facility equipment 116 may be used to determine facility equipment exclusion zone 518. This information in accordance with the defined capabilities of the particular autonomous mobile unit 106, 124 may then be used by control system 200 to update the route of autonomous mobile unit 106, 124 to avoid potential damage.

Control system 200 may then proceed to Step 620 as described in further detail with reference to FIG. 7. While the described embodiment proceeds through prioritization steps in FIG. 7, those skilled in the art will readily recognize that a high priority search area may take several forms depending on the manner of search performed by autonomous mobile unit 106, 124. A priority search area may be a single geocoded subunit 702 or may take any size composed of multiple subunits 702 as in grid search area 514. Grid search area 514 may act as an internal set of boundaries within environment 100, within which an autonomous mobile unit 106, 124 may travel and search for items of interest either according to a defined search pattern, randomly, or other pattern. By way of an alternative embodiment, autonomous mobile unit 106, 124 may be configured to travel randomly travel throughout the entirety of environment 100 bounded by an exterior perimeter and interior exclusion zones in search of items of interest.

For example, grid search area 514 in FIG. 5 is placed predominantly over an area of fallow waste site 414a. Once a priority search area is established, controller 102 may determine a route from the current location of autonomous mobile unit 106,124 to a selected priority search area (Step 624). Several examples of routes, including route 504 to grid search area 514, are shown in FIG. 5 and described above. In one embodiment, controller 102 may communicate route data to autonomous mobile unit 106, 124 operating within environment 100. In an alternative embodiment, autonomous mobile unit 106, 124 may calculate and determine a route plan independently. Autonomous mobile unit 106, 124 receiving a route plan from controller 102 may be at any location within environment 100 at the time a route plan is received. For example, autonomous mobile unit 106, 124 may be located at one search location having completed an earlier search or may be initializing a first search pattern (e.g., after charging at staging area 402). The route plan may be received by autonomous mobile unit 106, 124 in any form of data indicative of instructions for navigating from its present known location through environment 100. For example, a route plan may be communicated between off-board controller 102 and on-board controller 202 by transceiver 104, and 214 respectively.

Upon receiving or otherwise determining a route plan, autonomous mobile unit 106, 124 may travel to priority grid search location 514 using the route data provided or determined during Step 624. While travelling within environment 100, control system 200 may be configured to monitor peripheral sensor(s) 212 as described above in regard to FIG. 2 to monitor mechanical operations of autonomous mobile unite 106, 124, and/or may be configured to monitor camera(s) 108, 126 to detect and avoid hazards and/or obstacles not identified in the initial electronic representation during Step 614. Control system 200 may also actively monitor one or more of facility equipment 116, waste vehicle 114, etc. for updated activity. In one or more embodiments, autonomous mobile unit 106, 124 may be configured to activate and monitor signals generated by sensor(s) 212 and/or camera(s) 108, 126 to identify potential items of interest while travelling to a selected search area.

Upon arriving at the primary grid search location 514, autonomous mobile unit 106, 124 may enter search mode (Step 630). In some embodiments, it may be advantageous for autonomous mobile unit 106, 124 to travel to primary search locations using a minimum of sensors and locators in order to preserve power and/or computational. Upon commencing Step 630 onboard controller 202 may initiate monitoring sensor(s) 212, camera(s) 108, 126, and/or additional locator(s) 204 in order scan primary search grid location 514.

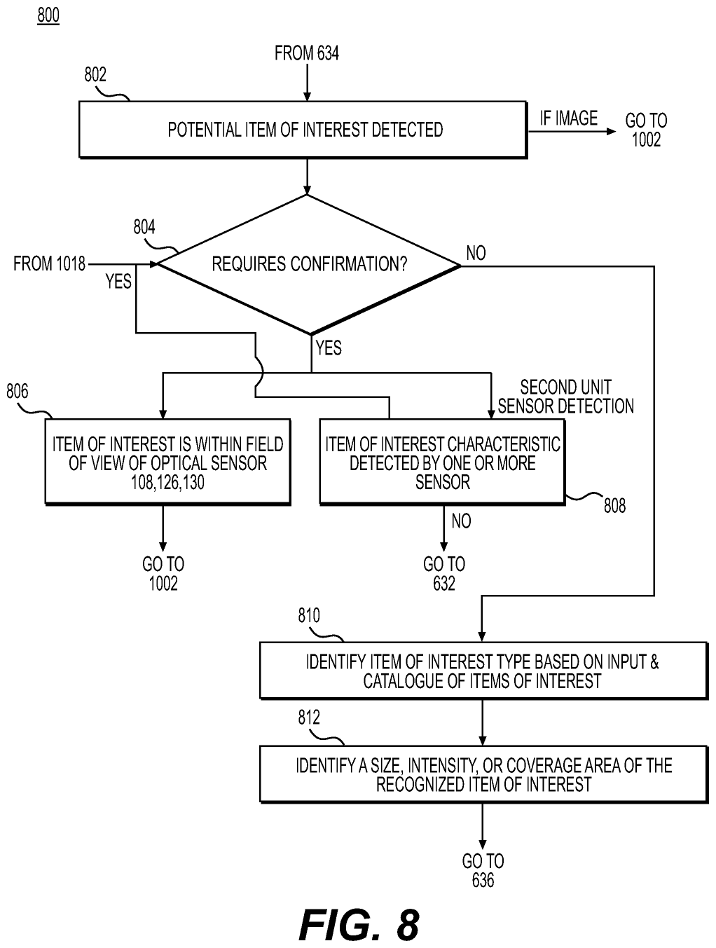

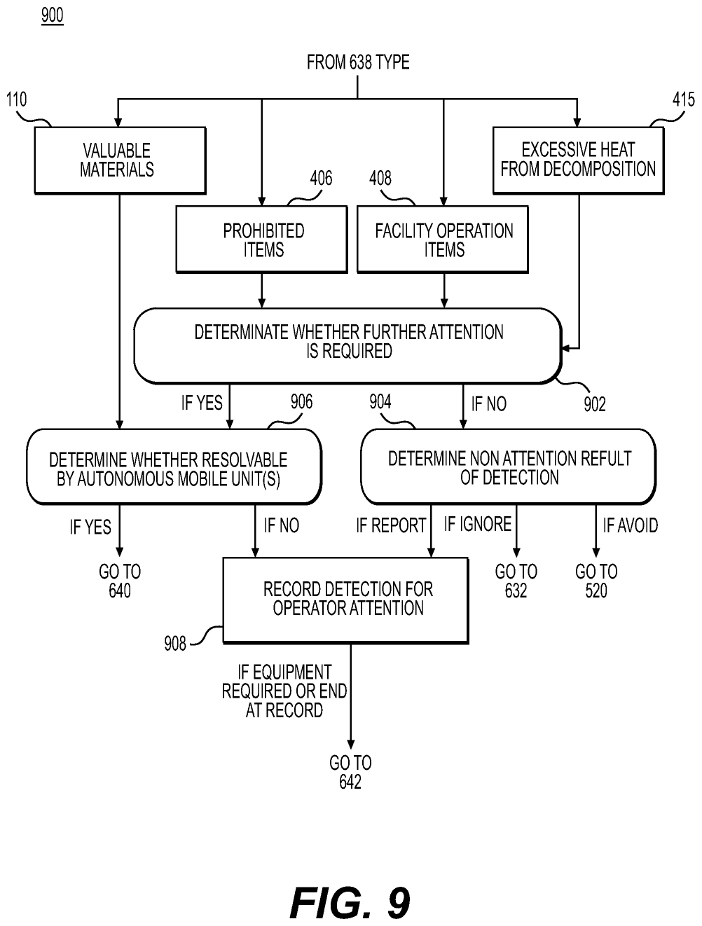

Primary grid search location 514 may comprise multiple geocoded subunits 708 as shown in FIG. 7. If sensor(s) 212 and/or camera(s) 108, 126 detect a potential item of interest, the system may proceed to Step 634 to confirm the detection of an item of interest (See FIG. 8). In the event that the detected item of interest cannot be verified, the system returns to Step 630 to resume search of primary grid search location 514. Where no item of interest is detected (Step 632), the system proceeds to Step 644. Upon confirmation of a positive detection of an item of interest, the system may send one or more signals to controller 102 reporting the detection of a confirmed item of interest (Step 636) and proceed to Step 638 to conduct a collectability analysis (See FIG. 9). Upon completing a collectability analysis, the system proceeds to Step 642 to flag the location of an uncollectable item of interest, or alternatively to Step 640 to collect the identified item of interest. Upon completing Step 642 of Step 640, the system may proceed to Step 644. In Step 644 the system determines whether it has completed its search of primary grid search location 514. If NO, the system returns to Step 630 to resume searching for items of interest within primary grid search location 514. If YES, the system then returns to Step 620 to select a new priority search location.

In one embodiment, primary grid search area 514 may comprise a predetermined number of subunits 708, in which case onboard controller 202 may be configured to search and log completed search of each subunit 708. Upon confirming that each subunit 708 within primary grid search area 518 has been searched, the system may mark primary grid search area 514 as completed prior to moving to Step 620. If the primary search area has not been completed the autonomous mobile unit may re-enter search mode (Step 630).

In Step 638 the system performs a collectability analysis having received a signal indicative of a confirmed detection of an item of interest characteristics and its location. The collectability analysis determines whether autonomous mobile unit 106, 124 is capable of collecting or otherwise remediating a detected item of interest. The collectability analysis is detailed in FIG. 9. If autonomous mobile unit 106, 124 is not capable of collecting or otherwise remediating the detected item of interest, the system may flag the location of the detected item of interest for site personnel to bring in the proper equipment to affect collection or resolution (Step 642). Control system 200 may then again determine whether a search of primary grid search area 514 has been completed (Step 644).

If autonomous mobile unit 106, 124 is capable of collecting or otherwise remediating the detected item of interest, the system may then proceed to collect or otherwise remediate the detected item of interest (Step 640) prior to determining whether a search of primary grid search area has been completed (Step 644). For example, in one embodiment autonomous mobile unit 106 may use manipulation mechanism 302 to manipulate, collect, and place the item of interest into an onboard storage compartment (not shown), or to drag the item of interest to an identified delivery location 522. If an item of interest is collected by autonomous mobile unit 106, 124, control system 200 may then proceed to Step 644 to determine if whether a search of primary grid search area 514 has been completed. If not, the system returns to Step 630 to continue searching primary grid search area 514 for items of interest. If YES, system 200 returns to Step 620 to select a new priority search location.

A delivery location may be autonomous mobile unit staging area 402, or another identified delivery location 522 in environment 100 (e.g. near active roadway 404, or anywhere that allows for further collection and remediation beyond environment 100). Once autonomous mobile unit 106, 124 completes delivery of item of interest to delivery location 522, 402, control system 200 may again determine if the primary search area 514 has been completed (Step 644). If not, the system returns to Step 630 to continue searching primary grid search area 514 for items of interest. If YES, system 200 returns to Step 620 to select a new priority search location.

FIG. 7 depicts one example of an analysis offboard controller 102 may conduct for the prioritization of search areas (Step 620). In Step 702, system 200 may divide environment overlay 500 into a series of geocoded subunits 708. Subunit 708 may be of any size, but in some embodiments each subunit 708 may be proportionate to the effective range of sensor(s) 212, or camera(s) 108, 126 range or field of view in order to allow for optimal or efficient allocation of system resources. A default priority level analysis hierarchy of factors is disclosed in table 704 of FIG. 7 for illustration purposes only and should not be viewed as limiting.

The priority level factors indicated in priority hierarchy table 704 may be of any number or type beneficial to system 200. Each primary search grid location 514 or subunit 708 may be assigned priority level factors that may be mutually exclusive. The depicted subunit priority types in table 704 include personnel confirmed, no history of search, unconfirmed object recognition, undisturbed waste, disturbed waste, delivery of waste, continued monitoring, completed contaminant remediation, and aerial search of ground exclusion. The default priority level factors in table 704 are listed in descending order from highest priority to lowest.

As data is entered about environment 100, priority level analysis 704 may recalculate the scanning priority level of a particular primary search grid location 514 or subunit 708. This recalculation may occur at any interval, in reaction to any scan performed by the system, or in response to any other information entered into control system 200. The time since the last scan may be an additional factor included in the overall prioritization of a given primary search grid location 514 or subunit 708 by incorporating the other priority factors shown on FIG. 7. For example, if control system 200 previously recorded a ‘continued monitoring’ factor for a given primary search grid location 514 or subunit 708, and a unit's assignment to continued monitoring ideally happens at a given interval, as the end of the time interval approaches, the overall priority of dispatching an autonomous mobile unit to that primary search grid location 514 or subunit 708 may rise.

Again, each primary search grid location 514 or subunit 708 priority factor may be recalculated by controller 102 or system 200 due to informational feedback. For example, in FIG. 5, the area of fallow waste site 414a may comprise multiple geocoded subunits 708 with priority factor ‘undisturbed waste’, if during previous tipping activity an item of interest was detected by camera(s) 130, that subunit 708 within the area of detection may be re-coded with a priority factor ‘unconfirmed object recognition’ having a higher priority than the surrounding subunits 708. In another example if a travel exclusion zone is removed for primary search grid location 514 or subunit 708 coded priority factor ‘delivery of waste,’ the assigned priority factor may automatically be re-coded ‘undisturbed waste’ prioritized for search above the other primary search grid location 514 or subunit 708 factor types except for ‘personnel confirmed’ or ‘unconfirmed object recognition’.

When control system 200 determines which primary search grid location 514 or subunit 708 to dispatch autonomous mobile unit 106, 124 to, it may compute the relative priority values of search grid location 514 or subunit 708 during a proximity to priority comparison (Step 706). This prioritization analysis may be accomplished by the controllers using any machine learning mechanism commonly used in the field of computer science for the solving of classic traveling salesman problems or an extension thereof, such as a traveling salesman problem with priority prizes. For example, a brute force approach, a nearest neighbor method, or branch and bound method.

During this calculation controller 102 may account for the travel restrictions created by travel exclusion zone(s), and initial location of autonomous mobile unit 106, 124 for which controller 102 is calculating a dispatch location. The incorporation of travel routes available to the autonomous mobile unit 106, 124 around exclusion zones may inform the calculations in determining the next highest priority location to be scanned. In this way it may be possible to scan several lower priority locations on the way to a higher priority location. Once the destination(s) have been calculated, controller 102 may determine route plans (Step 624).

Detection of an item of interest (Step 634), may further be broken down into a set of steps control system 200 may employ to differentiate a false reading or an initial detection of a characteristic of an item of interest from an item of interest itself shown in FIG. 8. In Step 802, the system monitors sensor(s) 212, or camera(s) 108, 126, 130 to detect a potential item of interest Potential detection can be determined by sensor(s) 212 or by neural network object identification beginning at Step 1002 (see FIG. 10). As discussed previously, various types of sensor 212 may be utilized by control system 200 to detect an item of interest Some sensor(s) 212 detect an item of interest itself (as in a pollutant in a gas sensor), while others sensor(s) 212 detect an item of interest indirectly by detecting some characteristic thereof (e.g. the characteristic electric conductivity indicating the potential presence of several types of metal). For this reason, it may be beneficial to require confirmation of the detection of an item of interest depending on the sensor(s) 212 that make an initial detection of an item of interest.

Depending on the type of sensor(s) 212 or camera(s) 108, 126, or 130 signaling detection of an item of interest, control system 200 may determine whether to require further confirmation of the item of interest (Step 804). In the event sensor(s) 212 or camera(s) 108, 126, or 130 detect an item of interest directly, as in the example of a pollutant, then no confirmation may be required, and the system may continue to identify the item of interest (Step 810). If sensor(s) 212 or camera(s) 108, 126, or 130 detect a potential item of interest indirectly further confirmation may be required. Where confirmation is required, it may be accomplished by object recognition if the detection is determined to have occurred within the field of view of camera(s) 108, 126, or 130 (Step 806) or by a second sensor(s) 212 detection (Step 808).

In those cases, the confluence of two or more detections in the same location recording different characteristics matching those from a predefined list may act as a detection of an item of interest not requiring confirmation (Step 804). For example: a magnetometer registers a magnetic field (a first detection (Step 802); possible from a further distance but with more possible sources), it requires confirmation (Step 804) in the same location an electric current metal detector (a second detection (Step 808); requiring closer distances yet are selective for electrical conductivity), the second detection no longer requires confirmation (Step 804), identification of an electrically conductive metal iron (or similarly reactive metal) may occur (Step 810).

While not a necessity, in the embodiment disclosed in FIG. 8, every object recognition detection (from a first view result in Step 1018) requires confirmation (Step 804), either by identifying it in a second image recorded in another view (Step 806), or a characteristic detected by sensor(s) 212 (Step 808). This may be accomplished because at the end of neural network object of interest identified (Step 1018) returns the system to step 804 to determine if there is a second view of the same object (Step 806; by recording a detection in the same location) or detection by one or more sensor(s) 212 (Step 808; by recording a second detection in the same location).

If no second view is available (currently unable to continue to Step 806), and no sensor(s) 212 may confirm the detection (currently unable to continue to Step 808), geocoded subunit 708 where the initial detection occurred may be reported to the controller prioritization system (shown in FIG. 7) to be labeled with a new prioritization factor ‘unconfirmed detection’. In this way, one or more additional autonomous mobile units may be dispatched to a flagged location to confirm or disaffirm the first detection of an item of interest. Confirmed and disaffirmed readings may also be used as feedback to further train control system 200 to recognize objects of interest.

Once a detection no longer requires confirmation all data about the detection(s) are consolidated to identify the item of interest (Step 810). While a specific item of interest may be determined at this step (i.e., valuable electronics 110 or valuable metal 111) the primary purpose is distinguishing between potentially valuable items 110, prohibited items 406, potential hazards 415, and facility operation items 408. Once a detection no longer requires confirmation (Step 804) all scannable attributes of the item of interest may be recorded, and object type may be identified by control system 200 integrating all available data.

Once an item of interest type has been determined, any additional attributes of an item of interest may be further qualified (Step 812). These attributes may include an exact location, size, area, intensity, or weight of the detected item of interest Characteristics of detected items of interest may be determined by aggregations of sensor detections, by requesting additional readings (in a similar manner as in an unconfirmed detection 708), or through computations performed by control system 200.

For example, size may be determined by comparison with other items of interest of known size, by calculating the focal length of optical sensor(s) that detect an item of interest in an image to measure its depth, assessment of the percentage of the field of view the object(s) of interest encompass(es), or any other mathematical computation utilizing a combination of the optical field, the known location of the optical sensor(s) and sensor(s) capabilities. Further, controller(s) may utilize augmented reality technology to gauge the size of objects, by automatically detecting the dimensions with light detection and ranging or laser imaging detection. Additionally, radar, sonar, or any other method of computing the time dilation of traveling waves may determine item of interest attributes.

The data compiled in steps 810-812 may then be used to conduct a collectability analysis (Step 638) by comparison to actionability requirements and the known functional parameters of the autonomous units (shown in FIG. 9). The type of item of interest determined in step 810, may determine what step is conducted first. For example, valuable materials 110, identified based on the data collected and catalog of items of interest in (Step 810), with known size parameters calculated in (Step 812), may be directly compared to the autonomous mobile unit capabilities, location, and current availability to determine if the item of interest is resolvable by autonomous units (Step 906). If the result is yes, then an autonomous mobile unit is directed to collect the item (Step 640). If not, the recorded detection data is recorded for personnel attention (Step 908) for personnel to resolve or determine if equipment is required (Step 642).

For prohibited items 406, potential hazards 415, and facility operation items 408 the first step would be to determine if any response by the system is warranted based on the condition recorded and predetermined threshold parameters (Step 902). If the answer is yes, then controller 102 may determine if the item of interest is resolvable by autonomous units (Step 906) and continues as above. If not, a further determination of the type of non-attention required (Step 904) may be performed. This step determines whether to avoid, ignore, or record the detected item of interest. For example, a prohibited item is detected but is not resolvable by mobile autonomous units (Step 906) but has characteristics of toxic materials (determined in Step 810), avoiding the location would be the correct action and an exclusion zone 520 is placed in the location of the detection.

In another example, a potential hazard 415 detected in the form of a thermal reading. With a value above that requiring attention (determined by Step 902 based on parameters set to differentiate between background temperatures and areas of high heat from composting), if no autonomous mobile unit is able to resolve the detection 906, the detection is recorded for operator attention 908. If the potential hazard 415 is of a value below that requiring attention (Step 902), other non-attention results of the detection (Step 904) may include that the detection could be ignored (i.e., it is substantially below a given threshold) and is recorded as a negative reading 632, or recorded for personnel attention (Step 908). It should be noted that in cases where reported detections were sent for personnel review the subunit 702 may also be re-coded with a prioritization factor (i.e., factor continued monitoring) by prioritization analysis (Step 704).

FIG. 10 illustrates one potential embodiment of a neural network object identification system. These processes may be completed at step(s) 802, 806 shown on FIG. 8. Images of objects of interest captured by camera(s) 108, 126 or 130 enter the system in the form of captured image data (Step 1002). This may be captured sensory input from either a first detection 802 or second view 806. Capturing image data via the corresponding camera(s) (Step 1002) may occur in multiple ways.

For example, fixed camera(s) 130, or camera(s) 108, 126 placed on autonomous unit 106, 124 may generate one or more images continuously. Control system 200 may receive, capture, record, retain, analyze, or otherwise use the images only when the predetermined conditions have been satisfied (i.e., times of day or facility processes). Alternatively, camera(s) 108, 126 placed on autonomous unit 106, 124 may generate the image(s) used by on-board controller 202 or off-board controller(s) 102 only when the associated conditions of step 630 have been satisfied and the autonomous mobile unit has entered a search mode. Controller(s) 102 may always receive, capture, record, retain, analyze, or otherwise use the images. Other strategies may alternatively or additionally be employed, if desired.

The image(s) captured at step 1002 may thereafter be analyzed by control system 200. Control system 200 may generate one or more bounding boxes within each captured image (Step 1004). Any method known in the art for generating bounding boxes may be implemented at step 1004. In one example, the bounding box(es) may be generated via a clustering algorithm, which creates a histogram of pixels containing similar parameter data (e.g., similar hues, tints, tones, shades, textures, brightness, reflectivity, luminescence, etc.). Each grouping of adjacent pixels within the histogram that contains similar data may be considered an independent object, and a virtual box (not shown) may be placed around each object and assigned one or more coordinates (e.g., a center coordinate, corner coordinates, boundary line coordinates, etc.) based on its position relative to all of the captured pixels within a parameterized range of sensor output and/or based on its position relative to known coordinates of camera(s) 108.

A data set for each bounding box may then be generated (Step 1006). The data set may include cumulative (e.g., mean, median, etc.) values for one or more (e.g., for each) of the pixel parameters discussed above, as well as collective parameters for the overall object (e.g., shape, size, location, parameter gradients, aspect ratio, etc.).

Control system 200 may utilize AI to determine if the data set is associated with an item of interest having been detected. For example, controller 202 may compare via one or more neural networks each data set to any number of predetermined conditions stored within a library of memory and known to be associated with an item of interest (Step 1008). The neural network(s) may include any number of different layers operating in parallel or series, each layer having any number of different nodes. Each layer of a given neural network may search for a different feature, parameter, and/or combination of features and parameters of an item of interest that is of importance to the operation of environment 100. Each node within each layer may analyze a different pixel of the data set.

When a specific pixel at a particular node within a layer of a given neural network has the parameter that the given layer is searching for (e.g., within a designated range), then that pixel may be weighted higher for that parameter (i.e., given a higher correlation of the data being associated with the item of interest). When the particular pixel at the particular node within the given layer does not have the parameter that the layer is searching for (e.g., the pixel has a parameter value outside of the designated range), then that pixel may be weighted lower for that parameter (i.e., given a lower correlation of the pixel grouping being associated with the target object(s)). It should be noted that, in some embodiments, different layers of the network(s) may give different weightings to the confidence values.

Depending on the correlation value assigned at a particular node within a given layer, analysis of the pixel may progress through the network(s) along different paths to different nodes in other layers. In this way, each pixel may pass through the network(s) from an input side to an output side and accumulate an overall confidence value during the progression. The confidence values of all pixels within a given grouping (e.g., the grouping associated with a given bounding generated at step 1006) may then be accumulated (e.g., summed).

In some instances, multiple images may be captured at Step 1002 that are associated with the same location or time. In order to inhibit duplication of efforts and/or logging of duplicate information, filtering of the data sets generated at Step 1010 may be selectively implemented. For example, Control system 200 may be configured to compare each newly generated data set with other previously generated data sets (e.g., data sets generated within a threshold period of time, such as within a previous 60 seconds) to determine an amount of similarity between the data sets (Step 1010). When values of a new data set are within threshold amounts of values of a data set generated within the last minute, Control system 200 may conclude that the new data set is a duplicate (Step 1012) and retain only the set having the higher confidence value(s) (Step 1014).

Control system 200 may then compare the confidence value(s) of the retained data set(s) to one or more threshold values associated with the item of interest (Step 1016). When the overall confidence value for a grouping of pixels within a common bounding box is greater than the threshold value associated with the item of interest, Control system 200 may determine that an item of interest at the known location has been detected (Step 1018). The library of features and parameters associated with items of interest stored within the memory 220 may then be updated with the data set Control system 200 may then continue to Step 804.

Returning to Step 1016, when the overall confidence value for a grouping of pixels from a common bounding box is less than the threshold value associated with the target object, controller 202 may determine that an item of interest has not been detected (Step 1020). Controller 202 may then return to Step 632.

It will be apparent to those skilled in the art that various modifications and variations may be made to the disclosed system. Other examples will be apparent to those skilled in the art from consideration of the specification and practice of the disclosed system. It is intended that the specification and examples be considered as illustrative only, with a true scope being indicated by the following claims and their equivalents.

What is claimed is:

1. A system for managing a waste, storage, or recycling facility environment comprising:
an autonomous mobile unit;
a locator mounted onboard the autonomous mobile unit configured to generate a first location signal indicative of a location of the autonomous mobile unit;
a first sensor mounted onboard the autonomous mobile unit configured to generate an item detection signal indicative of a property of an item of interest in the vicinity of the autonomous mobile unit; and
a controller in communication with the locator and sensor, the controller being configured to:
determine, based on the location signal a travel route to a selected search area;
automatically detect, based on the item detection signal, the existence of an item of interest within the vicinity of the autonomous mobile unit; and
automatically generate a signal indicative of instructions to collect, flag, or remediate an item of interest in response to the detection.

2. The system of claim 1 wherein the item of interest is one of an item of value, a contaminated area, and an area of excessive heat.

3. The system of claim 1 wherein the signal indicative of instructions to collect, flag, or remediate an item of interest causes the autonomous mobile unit to automatically collect the detected item of interest;

4. The system of claim 1 wherein the first sensor is an infrared radiation detector.

5. The system of claim 1 wherein the first sensor is a camera.

6. The system of claim 1 wherein the route assignment comprises one or more of a travel path, location co-ordinates to be searched, and a search pattern.

7. The system of claim 1 wherein the controller is receiving a second signal from at least one sensor not deposited onboard the first autonomous mobile unit to identify objects of interest, and automatically provide route assignment to the first autonomous mobile unit when objects of interest are detected by the second sensor.

8. The system of claim 1 wherein a route assignment is determined based on current, past, and scheduled locations and/or activity of one or more autonomous mobile units.

9. The system of claim 1 further comprising a second location sensor deposited onboard facility equipment, wherein the controller automatically updates the route assignment of the first autonomous mobile unit to avoid the facility equipment.

10. The system of claim 1 wherein the route contains one or more temporary and/or permanently restricted travel locations to be avoided.

11. The system of claim 10 wherein the temporary restricted area is prioritized for route assignment when the restriction is removed.
